(19) United States
(12) Patent Application Publication
(10) Pub. No.: US 2016/0314475 A1
(43) Pub. Date: Oct. 27, 2016

(54) METHOD AND SYSTEM FOR VERIFYING OF THE AUTHENTICITY OF A CONSUMER PRODUCT

(71) Applicant: OMNIBLEND INNOVATION PTY LTD, Brooklyn, Victoria (AU)

(72) Inventors: Arie NUDEL, Caulfield North, Victoria (AU); Gottfried LICHTI, Essendon, Victoria (AU)

(21) Appl. No.: 15/106,086

(22) PCT Filed: Dec. 16, 2014
(86) PCT No.: PCT/AU2014/001136

§ 371 Date: Jun. 17, 2016

(30) Foreign Application Priority Data
Dec. 17, 2013 (AU) 2013904931

(51) Int. Cl. G06Q 30/00; G06K 7/10; G06K 19/06; G06F 17/30

(52) U.S. Cl. CPC G06Q 30/0185; G06F 17/30879; G06K 7/10861; G06Q 30/014; G06K 19/06056; G06K 2009/0059

(57) ABSTRACT

A method and system is provided for verifying of the authenticity of a consumer product, the method including: providing an overt code on a consumer product, the overt code being readable prior to sale of the consumer product; providing a covert code on the consumer product, the covert code being revealed post sale of the consumer product; receiving a transmission of the covert code from a purchaser of the consumer product; verifying the covert code by reference to a database; if the covert code verifies the authenticity of the consumer product, transmitting an authentication signal to the purchaser; and cancelling the covert code and the overt code once the covert code has been used to verify the authenticity of the consumer product.

### FIELD OF THE INVENTION

The present invention relates generally to methods and systems for verifying of the authenticity of a consumer product. The invention relates more particularly to methods and systems that enable a purchaser to be satisfied that a consumer product was sourced from an authorised source and is a verified authentic product.

### BACKGROUND TO THE INVENTION

Trade in counterfeit goods is a lucrative and growing area. Counterfeiting is often perceived as a victimless crime with counterfeit goods simply providing an alternative purchase having a lower price, and is regarded by the counterfeiters themselves as having a low risk of prosecution relative to the significant profits to be made. However in reality, product counterfeiting and fraud jeopardises public health and safety, poses a serious risk to national industries and undermines legitimate business.

The range of counterfeit products available is broad and trends indicate that counterfeiters no longer confine their activities to luxury goods such as apparel and electronics but are increasingly turning to consumer goods, such as pharmaceuticals, alcohol, cigarettes, dairy powders, baby food and cosmetics. Counterfeiting consumer goods is not only illegal but constitutes a serious threat to public health and safety, since counterfeit consumer products are not subject to the usual regulatory checks that maintain product safety standards.

Accordingly whilst the availability of counterfeit apparel and electronics is a significant financial and economic issue in terms of loss of revenue for the authorised manufacturer and the potential to damage the reputation of the brand due to poor quality counterfeit goods, there are also serious health and safety implications associated with consumers unknowingly purchasing and consuming certain counterfeit consumer products including food products, cosmetics and drugs. Illness and harm has resulted from the consumption of counterfeit consumer products including adverse reactions that may lead to hospital admission and even death. It is widely known, for example, that there have been cases of counterfeit infant formula containing melamine which has resulted in the illness of thousands of children in China in addition to a number of fatalities.

As the quality of the packaging used by counterfeiters continues to improve, it is increasingly difficult for consumers and enforcement agencies to distinguish between authentic and counterfeit goods. New methods are required to provide confidence to consumers that the product on offer is attributable to an authorised source.

Whilst various attempts have been made to provide security labels, these have a number of drawbacks. Such validation systems typically generate a unique code, e.g. a string of alphanumeric characters in text or a barcode, and attach the resulting label to a consumer product. The label may be validated using a variety of means employing a web browser or SMS. However, the response generated relates to the validity of the label, that is, it indicates whether the label itself is authenticated and the product is merely authenticated by association. Accordingly such means inherently provide opportunities for misuse by label relocation that is, transferring the label from an authentic product to a counterfeit product, and the fraudulent acquisition of labels. In both cases, the label will generate a valid authentication response although the product itself is counterfeit. Moreover, web browser based authentication systems are vulnerable to counterfeiters due to the relative ease of creating counterfeit security labels which point to a fraudulent authentication website which in turn returns a false product authentication to the consumer.

Moreover, there is an ongoing need for brand-owners to communicate more effectively with consumers, and to provide information that will enable consumers to derive more benefit from products. The benefit to the consumer may lies, at least in part, in confidence that the product is authentic.

A reference herein to a patent document or other matter which is given as prior art is not to be taken as an admission that that document or matter was, in Australia, known or that the information it contains was part of the common general knowledge as at the priority date of any of the claims.

### SUMMARY OF THE INVENTION

According to an aspect of the present invention, there is provided a method for verifying of the authenticity of a consumer product, the method including the following steps: a) providing an overt code on a consumer product, the overt code being readable prior to sale of the consumer product; b) providing a covert code on the consumer product, the covert code being readable post sale of the consumer product; c) receiving a transmission of the covert code from a purchaser of the consumer product; d) verifying the covert code by reference to a database; e) if the covert code verifies the authenticity of the consumer product, transmitting an authentication signal to the purchaser; and f) cancelling the covert code and the overt code once it has been used to verify the authenticity of the consumer product.

The method may further include the step of transmitting information regarding one or more discernible product attributes of the consumer product to enable the purchaser to verify that the consumer product matches the one or more discernible product attributes. In one embodiment, a first set of one or more discernible product attributes are associated with the overt code and a second set of one or more discernible product attributes are associated with the covert code. The second set of one or more discernible product attributes may include the first set of one or more discernible product attributes and additionally at least one other discernible product attribute. In this case, preferably at least one other discernible product attribute is not discernible until post purchase. For example, the at least one other discernible product attribute might be a specific colour of a scoop that cannot be discerned until the packaging has been opened by the purchaser.

The method may be preceded by the steps of generating the overt and covert codes and associating a code pair comprising one overt code and one covert code in a database. In one embodiment, this entails associating a pair of overt and covert codes which will be applied to the same consumer product. The step of associating a code pair preferably occurs at a secondary location that is remote from one or more primary locations where the overt and covert codes are generated. Moreover, the secondary location is further preferably remote from a location where the consumer goods are manufactured and/or the code pair is applied to the product. In a particular embodiment, the secondary location is associated with an authentication authority.

In the event that the covert code does not verify the authenticity of the consumer product, the method may further include the step of transmitting a failure to authenticate signal to the purchaser together with a request for information relating to acquisition of the consumer product. This enables the authorised source of the consumer product to obtain information regarding counterfeit products including their location, and the identity of the entity offering the counterfeit product for sale.

In one embodiment, the method further includes the step of receiving an application for registration from a purchaser; wherein the application for registration is received prior to receipt of the transmission of the covert code. The registration step is executed once only for each purchaser of the consumer product. Purchaser registration significantly simplifies recall procedures in the event that a product recall or similar requirement to contact purchasers arises at some time in the future. Furthermore, securing registrations of purchasers, enables the authorised source of the consumer product to collect valuable information regarding demographics and buying habits of purchasers of the consumer products.

In one particular form of the invention, the method further includes the step of transmitting information regarding a product recall affecting the authenticated consumer product to the purchaser.

In another embodiment, the method further includes the step of providing a batch code on a collection of consumer products, the batch code being associated with data that identifies the collection of consumer products prior to sale. The provision of batch codes offers advantages for tracking larger volumes of the consumer product throughout the distribution channel. Batch codes are readable during distribution and no longer readable once the consumer product is offered for sale in a retail environment. For instance, the batch code may be provided on a carton which holds a plurality of individually packaged consumer products. The batch code therefore is used to track “batches” of the consumer product and is directed to product tracking rather than authentication.

In one particular form of the invention, information regarding a product recall affecting the consumer product is transmitted to a distribution channel intermediary based on the batch code. Preferably, the distribution channel intermediary is the retailer or wholesaler.

The consumer product may be any type of consumer product including but not limited to apparel, sporting goods or electronics. In one particular embodiment, the consumer product is a perishable product such as alcohol, cigarettes, pharmaceuticals or nutraceuticals. In another embodiment, the consumer product is an edible product such as food including baby food, dairy products, meat and meat products. In yet another embodiment, the consumer product is a multiple-use product intended for use by infants and children, e.g. infant formula.

According to another aspect of the present invention, there is provided a system for verifying of the authenticity of a consumer product, the system including: a) one or more code generating modules for providing an overt code and a covert code, wherein the overt code and the covert code are both to be applied to the consumer product; b) a database for associating the overt code with data that identifies the consumer product and the covert code with data that can be used to authenticate the consumer product; c) a receiving and transmission module for receiving a transmission of the covert code from a communication device associated with a purchaser of the consumer product and transmitting an authentication signal to the communication device via a network, if the covert code verifies the authenticity of the consumer product; and d) a code cancellation module for cancelling the covert code and the overt code once the covert code has been used to verify the authenticity of the consumer product.

In one embodiment, the system further includes a code linking module for associating a code pair comprising one overt code and one covert code in a database. The associated code pair may be physically linked. For example in one embodiment, the overt code may be applied as an adhesive label over the covert code which also constitutes an adhesive label. In this configuration, the overt and covert codes can be simultaneously applied to the consumer product as a dual layer security label in a single step. In another embodiment, the overt code is printed on a surface which can be removed, for example, by scratching, over the covert code. In yet another embodiment, the covert code is concealed by removable means and the overt code is printed elsewhere on the consumer product. In this particular case there is no physical link between the overt code and the covert code.

The code linking module may reside at a secondary location that is remote to one or more primary locations where the one or more code generating modules reside. Moreover, the secondary location is also located remotely from a location where the consumer goods are manufactured and/or the overt and covert codes applied to the product.

The overt code preferably comprises a machine readable code.

The covert code also preferably comprises a machine readable code.

In one form of the invention, the machine readable code comprises a QR or “Quick Response” code.

The covert code may be concealed beneath the overt code. This functionality could be provided by way of a peel-off or scratch-off label comprising the overt code which can be removed from the packaging once the consumer product has been disposed of, i.e. sold and the purchaser wishes to authenticate the consumer product. Accordingly, the overt code may be removed by a purchaser to reveal the covert code post purchase of the consumer product.

The machine readable codes may be read by a scanner associated with the communications device. The communications device may be a smart phone or other device connected to a communications network that has analogous functionality.

The system may further include a database for storing information related to the consumer product, the information relating to the consumer product being transmitted to the communications device together with the covert code. The information related to the consumer product could comprise information regarding special offers related to the consumer product, new products or services, or any other information that the authorised source of the consumer product may wish to communicate to the purchaser.

### BRIEF DESCRIPTION OF THE DRAWINGS

The invention will now be described in further detail by reference to the accompanying drawings. It is to be understood that the particularity of the drawings does not supersede the generality of the preceding description of the invention.

FIG. 1A is a flowchart demonstrating the steps involved in a method for verifying of the authenticity of a consumer product.

FIG. 1B is a flowchart demonstrating the steps involved in a method for verifying of the authenticity of a consumer product according to another embodiment.

FIG. 2 is a schematic diagram showing a computer-enabled system for performing the method illustrated in FIG. 1.

FIG. 3 is a schematic diagram showing one embodiment of a system for applying the code pairs to a consumer product.

FIG. 4 is a schematic diagram showing the elements of a kit for verifying the authenticity of a consumer product.

FIG. 5 is a schematic diagram showing various functional elements of the computer-enabled system of FIG. 2 in block form.

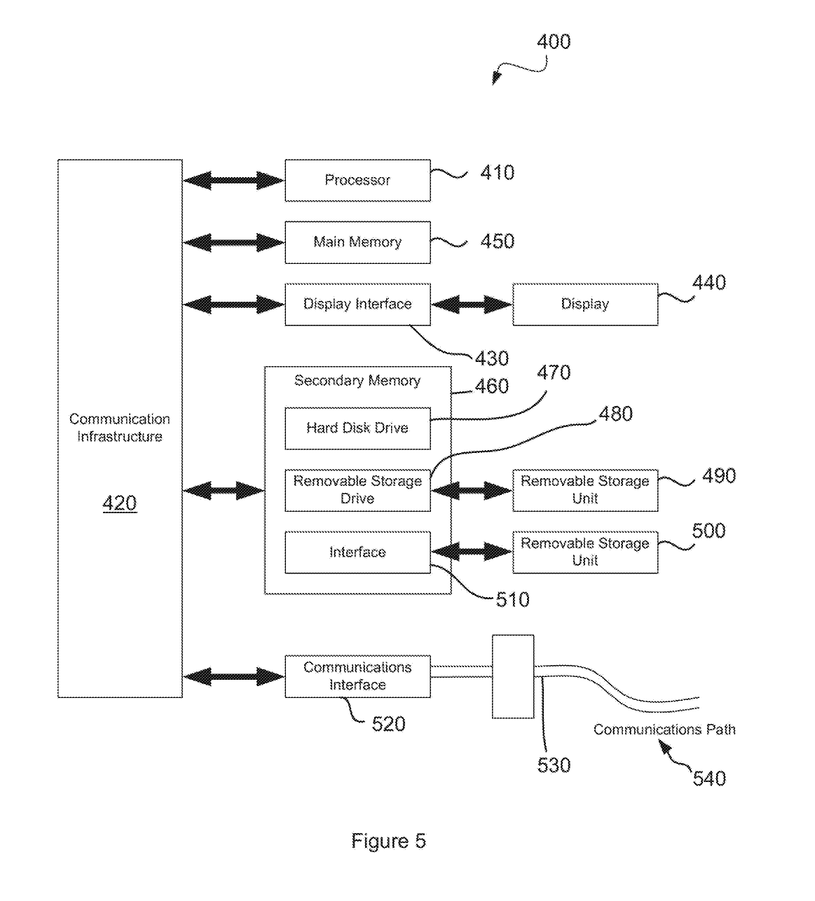

### DETAILED DESCRIPTION

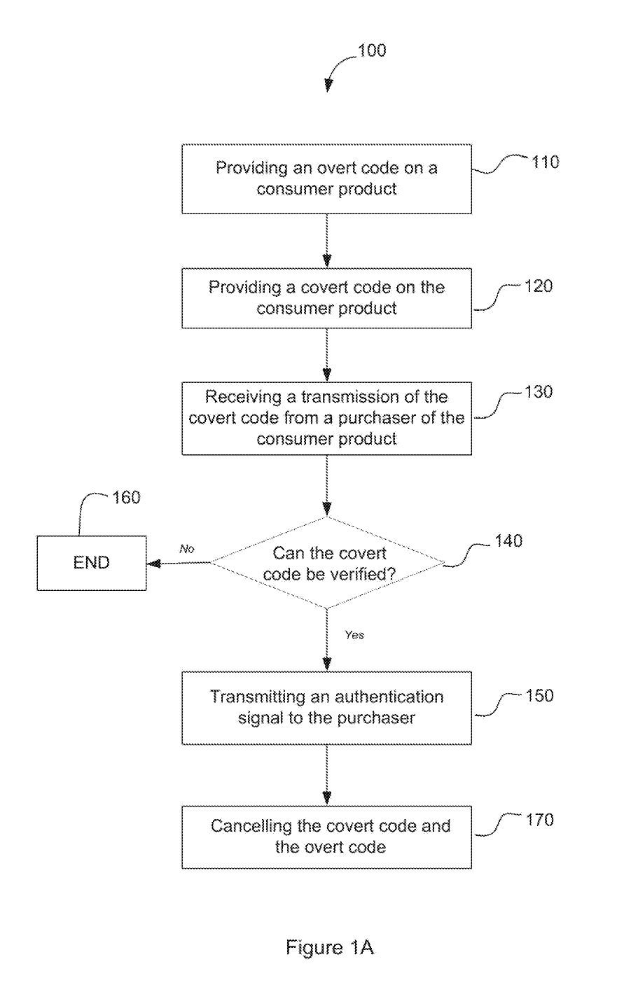

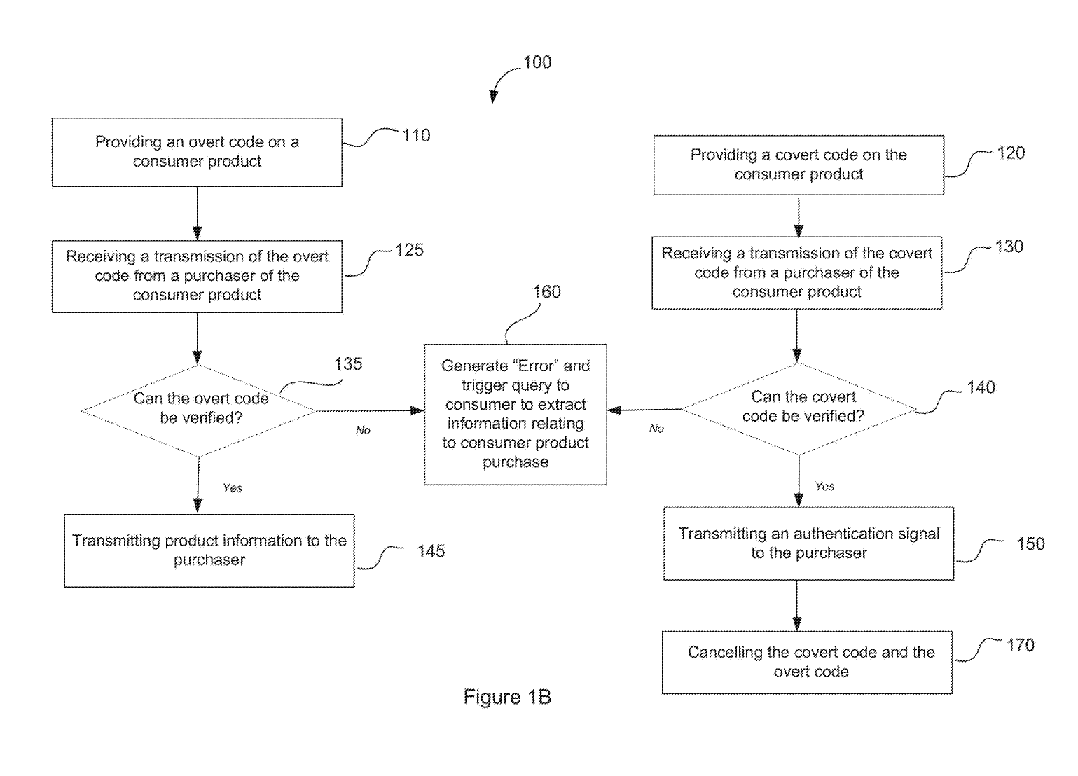

Referring firstly to FIG. 1A, a method for verifying of the authenticity of a consumer product 100 is described. The consumer product to be authenticated may be any suitable consumer product including an item of apparel, sporting apparel or electronics for example, or a consumable product such as pharmaceuticals, alcohol, cigarettes, infant formula, packaged food, or cosmetics. The consumer product may be of the type presented in some sort of package or container or may simply have a label attached. In either case, the container, package or label provides a surface upon which an overt code and a covert code may be provided.

At step 110, the method provides a first code in the form of an overt code on a consumer product. The overt code is associated with data that identifies the consumer product. That is, the overt code and the data are associated in a database. The overt code is intended to be readable throughout the distribution process, and in particular, prior to sale of the consumer product.

At step 120, the method provides a second code in the form of a covert code on the consumer product. The covert code is associated with data that can be used to authenticate the consumer product. That is, the covert code and the authentication data are associated in the database. Unlike the overt code, the covert code is intended to be readable only post sale of the consumer product. A link exists between the overt code and the covert code in the database. It is to be understood that the order of steps 110 and 120 may be reversed, for instance in physical application of the codes, wherein the overt code is applied over, or on top of, the covert code.

At step 130, a transmission of the covert code is received from the purchaser. The covert code is verified by reference to the database. If the covert code is verified, then an authentication signal will be transmitted to the purchaser at step 150. If the first covert code is not verified at step 140, the verification process is terminated at step 160.

At step 170, the code pair comprising an overt and a covert code is cancelled once the covert code has been used to verify the authenticity of the consumer product. “Cancelling” effectively means that the relevant codes are “silenced” whether deleted or otherwise removed from a list of codes that will generate an authentication response from a scan request. This self-cancelling feature prevents a single covert code from being used to authenticate a product on more than one occasion. That is, the covert code is effectively a single use code for the purposes of authenticating a product, thereby inherently increasing the security of the authentication method of the present invention. The covert code may however, be scanned post authentication by the purchaser to provide information regarding the consumer product. Such information may include a description of the product, and information regarding availability for a repeat purchase. However the covert code functions one time only as an authentication code.

The overt code is a multi-read code which can be read any number of times throughout distribution of the consumer product. That is, unless or until the overt code is removed to reveal the covert code which may be concealed beneath depending on the physical configuration of the code pair. Reading the overt code provides valuable information regarding the identity of the product prior to purchase of the consumer product.

Referring now to FIG. 1B, a method for verifying of the authenticity of a consumer product 100 according to another embodiment is described. This method is much the same as that described with reference to FIG. 1A except that it includes some additional steps wherein the overt code is separately verified at step 135. If the overt code fails to verify at step 135, then an “Error” message will generate at step 160 to alert the consumer that the product appears to be counterfeit, and optionally to present a brief questionnaire to the consumer in an effort to extract useful data relating to the attempted purchase of the counterfeit product, such as location, store details, date, time, etc.

If the overt code is verified at step 135, then product information which generally identifies the product is displayed to the scanning entity at step 145, whether the scanning entity be a potential purchaser of the consumer product, or part of the distribution chain.

The remaining steps 120, 130, 140, 150 and 170, are analogous to those described with reference to FIG. 1A.

Optionally, in the event that the covert code cannot be verified and the consumer product is suspected as being counterfeit, a message is transmitted to the purchaser, advising that the consumer product is suspected as being counterfeit. This message may be supplemented with advice not to consume the suspect consumer product and/or a request for information identifying a date, time and place where the suspect consumer product was purchased. In such a case, the authorised source of the product is provided with the details of the suspect consumer product to enable necessary investigations to be undertaken as to the origin of the counterfeit consumer product.

Cancellation of the code pair, i.e. the overt code together with the associated covert code, could occur at any suitable time, for instance, it is envisaged that cancellation of the codes may occur immediately post scanning of the covert code. Alternately, cancellation of the overt and covert codes may occur subsequent to an authentication signal being transmitted to the purchaser.

The overt and covert codes form a code pair placed on a consumer product for security purposes. Each code is a unique or substantially unique identifier associated with the consumer product, that is, there is a one-to-one correspondence between a set of overt codes and a set of consumer products and a one-to-one correspondence between a set of covert codes and the set of consumer products. Substantially unique is to be understood to require at least 95% of codes to be unique, preferably at least 99% of codes to be unique and more preferably at least 99.9999% of codes to be unique.

The codes may consist of a string of ASCII characters for example. The physical manifestation of the codes may be a label, typically comprising a machine readable code, for example a bar code. The bar code can be a two dimensional bar code, sometimes referred to as a QR or “Quick Response” code. Hence the overt and covert codes may be referred to by the designation QR1 and QR2, respectively.

An independent authentication authority may be responsible for generating the overt (QR1) and covert codes (QR2) and transmitting them to a label printer. The manufacturer provides consumer product identifying and associated information to the authentication authority which links this information to an overt code or covert code in a database. The covert code will preferably contain some additional information which is only transmitted post purchase. At this point the pair of codes, i.e. QR1 and QR2, becomes active (i.e. capable of responding to a scan request).

Moreover, since a security label includes an overt code which relates to a specific product, they are not transferable between manufacturers, or even between products produced by the same manufacturer. In fact, preferably, security labels are not even transferable between different batches of the same consumer product.

The steps of the method may be performed by or under authorisation by a authentication authority which may or may not be the same entity that is the authorised source of the consumer product, e.g. the consumer product manufacturer. Alternately, it is envisaged that a consumer product verification service as described, could be provided by some independent entity that is authorised to provide a verification service on behalf of the authorised source of the consumer product.

The verification method of the present invention is intended to be interactive, thereby involving the purchaser in the authentication process to give the purchaser a high degree of confidence in the authentication process. The purchaser may implement the verification method using an application on a smart phone or similar hand held device. Alternately, the method could be implemented via a browser available via a smart phone or similar hand held device provided that the device is connected to a communications network. However, a web interface is significantly less secure and more likely to be subject to “phishing” or similar security breaches.

Once the covert code has been scanned, in addition to transmitting an authentication signal to the communication device, the authentication signal may be accompanied by product description information to further enable the consumer to be satisfied that the product is authentic based on a visual check. For example, the product description information will typically relate to package contents, i.e. aspects of a consumer product that is not discernible from viewing the external features of the product. In the example where the consumer product is a consumable product such as a pharmaceutical or infant formula, the product description information could indicate visual characteristics of the product, e.g. “the contents of the packaging are a cream/white/granular powder” or “the package contains a blue scoop for dispensing the contents”. This allows the consumer to satisfy him or herself by a visual check of the contents that because the description matched the contents and has passed the other authentication steps, the product is safe for consumption.

Preferably, the purchaser is required to register with the authentication authority prior to using the verification method. In order to register, the purchaser must provide contact details such as a telephone number and email address and preferably, other details to enable the authentication authority, or the authorised source of the consumer product, to obtain some demographic data relating to the purchaser, that is data such as gender, age, ethnicity, location and employment status. A purchase history can subsequently be established for a registered purchaser. Where the purchaser is registered with the authentication authority, the purchaser is enabled to retrieve information regarding the consumer product by scanning the formerly “covert” code post authentication of the product.

The method may further include the step of providing a batch code on a collection of consumer products. In this case, the batch code is associated with data that identifies the collection of consumer products prior to sale. For example, batch codes QR3, QR4, etc., are associated with product batches (e.g. for shipper boxes that each contain x cans of consumer product, and for pallets that each contain y shipper boxes. These batch codes are unique identifier codes for the batch (not individual items of consumer product).

The overt, covert and batch codes are randomly generated. However before any of these code types are transcribed onto a label to be placed on a consumer product, the code might be modified (usually by adding one or more characters) so that the code can be rapidly identified as a valid code associated with the authentication system, i.e. an overt or covert code. This enables rapid means of identification by a scanner (provided in a smart phone) without the requirement for remote communication. That is, by distinguishing valid codes, a rapid and local means of identifying false codes is provided. One means of implementing this rapid identification strategy is through use of a checksum algorithm. For example, if the code is a string of 8 digits, two further digits are added to the end of the string of digits such that the sum of the original string of 8 digits comprises the last two digits. It is to be understood that there are a variety of alternative checksum algorithms or non-checksum algorithms that could serve a similar purpose.

The provision of batch codes offers advantages for tracking larger volumes of the consumer product throughout the distribution channel. The batch codes are readable during distribution and no longer readable once the consumer product is offered for sale in a retail environment. For instance, the batch code may be provided on a carton which holds a plurality of individually packaged consumer products. The batch code therefore is used to track “batches” of consumer product and is directed to product tracking rather than authentication.

Information regarding a product recall affecting the consumer product can be transmitted to a distribution channel intermediary based on the batch code. That is, following the identification of a product security issue, information regarding a product recall can be pushed to a smart phone application of the type previously described, enabling direct flow of information to current potential consumers (in the case of edible and/or perishable consumer products), e.g. recent purchasers of the relevant consumer product. Having only a small amount of geographic location information associated with purchasers through voluntary registration, can be sufficient to allow an authorised source of a consumer product to determine the location of affected batches of product and isolate the regions where a suspect consumer product may have been distributed.

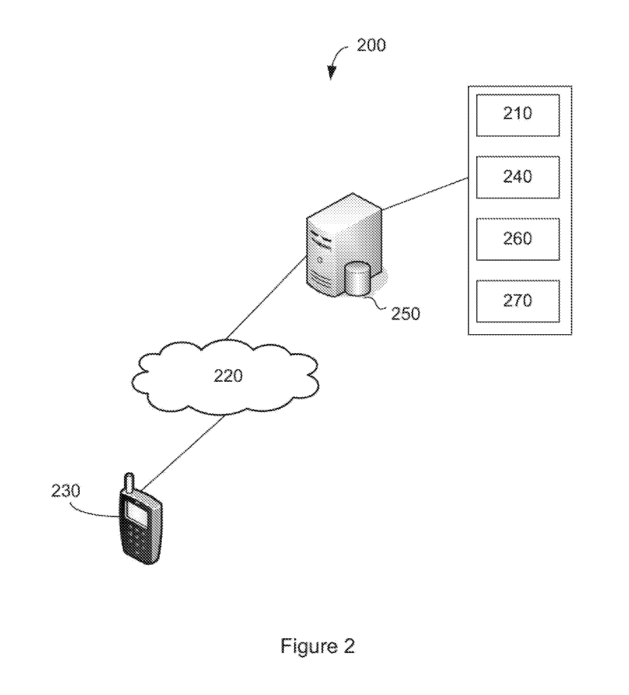

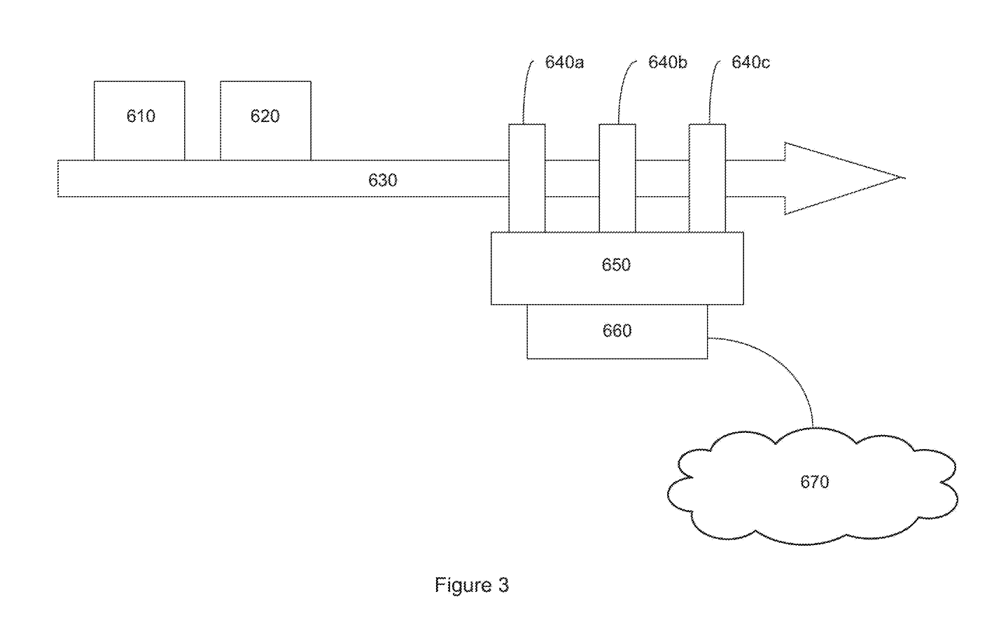

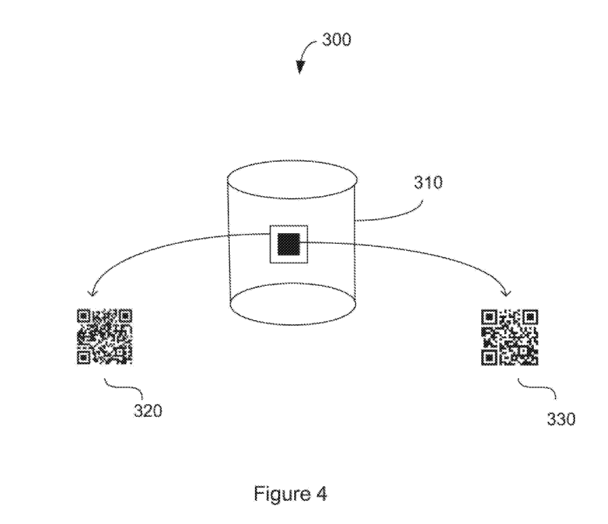

Referring now to FIG. 2, the verification steps of the method described with reference to FIG. 1 are implemented using a computer system. A code generating module 210 provides an overt code and a covert code. Both the overt code and the covert code are applied to the consumer product (see FIGS. 3 and 4).

In database 240, the overt code is associated with data that identifies the consumer product and the covert code is associated with data that can be used to authenticate the consumer product. That is, the database 240 may comprise a single database, or may comprise a plurality of databases, i.e. with the overt codes and their associated data being stored in a first database, and the covert codes and their associated authentication data being stored in a second database. Links will exist between the overt code and the relevant covert code applied to a single consumer product. Alternately, the code pairs may exist in a single table in a database linked to a number of other tables (most likely in the same database although possibly in another database) that contains all the relevant product information and images. Further tables in the same database could contain information such as manufacturer details, consumer data, feedback and various returned data and statistics arising from consumer interaction with the system.

A receiving and transmission module 260 is provided for receiving a transmission of the covert code from a communication device associated with a purchaser of the consumer product and transmitting an authentication signal to the communication device via a network 220. The authentication signal is only transmitted where the covert code verifies the authenticity of the consumer product. If the covert code does not verify the authenticity of the consumer product, no authentication signal is transmitted to the purchaser. Instead a message may be transmitted to the purchaser advising that the purchased consumer product is suspected of being counterfeit and optionally requesting the purchaser provide information to enable the source of the counterfeit consumer product to be identified.

A code cancellation module 270 is also provided for cancelling the covert code and the overt code once it has been used to verify the authenticity of the consumer product. Cancellation of a code effectively means that the code can no longer be authenticated such that duplication of an overt or covert code by counterfeiter will not work. It need not require that the relevant code, or its associated information, be literally deleted or otherwise removed from the database. Cancellation of a code may entail assigning “ownership” of a particular code to the purchaser, when the purchaser scans the covert code. Assigning, linking or otherwise associating the “cancelled code” with the purchaser in this manner means that the particular code is effectively cancelled for all other consumers. This function may be performed by the authentication authority, for example.

The purchaser of the consumer product scans the covert code provided on the consumer product using a communications device 230 associated with the purchaser. The communications device 230 may be a smart phone, personal digital assistant, personal computer or similar computing device connected to a communications network 220. The communications network 220 preferably provides wireless network access. The receiving and transmission module 260 receives a transmission of the covert code from the communications device 230 via the communications network 220. The database 240 verifies the authenticity of the covert code.

Verification effectively involves matching the transmitted covert code to one or a plurality of issued covert codes for the consumer product. If the covert code can be verified, an authentication signal is transmitted to the communications device 230 via the communications network 220.

Referring now to FIG. 3, the overt code and the covert code may be applied to the consumer product 610, 620 in any one of a number of ways. For example, as a dual layer adhesive security label described in more detail with reference to FIG. 4. Or alternately, applying the code pair on a production line including a unit comprising of a three head in-line printer 650 facing a moving conveyor 630. The print heads 640a, 640b, 640c are ordered so as to print the covert code, a concealment layer and the overt code either over the concealment means or elsewhere on the consumer product 610, 620, as the consumer product passes the relevant print heads on a conveyor belt 630. The concealment means could be for example, scratchy ink which displays evidence of tamper when removed. The code generating module 660 is associated with the printer 650 such that the code pairs are either supplied to the printer or more generated on-site and communicated to the authentication authority via a communications network 670.

As previously described, it may be a requirement that the first time a purchaser uses the verification service, the purchaser is required to register some personal details in order to gain access to the verification service. For example, upon registration the purchaser may be required to provide one or more items of personal data such as a full name, email address, telephone number, street address, date of birth and the like. This data may be further supplemented by positional data, e.g. the location of a smart phone providing the scanning capability being determined by an integral GPS component. This personal data is stored in a secondary database 250. The data stored in the secondary database 250 has various market research and targeted marketing applications since personal details can be linked with consumer purchase history.

For instance, as part of the verification process, the purchaser can be provided with marketing material relevant to the consumer product in question. For example, in the case of infant formula, the purchaser could be provided with general information and tips relating to infant health, advertising relating to other baby products whether they be other infant food products, or other baby products such as clothing or toys, and also marketing material of a more general nature.

Consumer products may also be functional foods and therapies for use by people who wish to manage a chronic condition (such as diabetes), or who wish to reduce the risk of disease or disease progression. Consumers may derive benefit not only by using the product, but also by making lifestyle changes such as taking more exercise. There is scope to include “nudges” to promote improved health outcomes in the information provided to the consumer after authentication. For consumers that are registered with the system the “nudging” can be focused, directed and adapted to the individual consumer based on analysis of historic data and interaction.

The authentication authority may operate a range of reward and loyalty schemes. For example, a retrospective reward scheme provides rewards to consumers on the basis of products that were purchased before the reward scheme is announced. The purpose of the retrospective reward scheme is to motivate consumers to become registered scanners (i.e., to initialise the smart phone application). Other reward schemes might be brand/manufacturer specific.

The covert code is a machine readable code, for example a bar code. The bar code is a two dimensional bar code, sometimes referred to as a QR or “Quick Response” code. A two dimensional bar code reader is provided within the application provided on the smartphone or similar hand held communications device associated with the purchaser.

The covert code may be hidden from view by removable concealment means. That is, the covert code may not be readable, until the removable concealment means is removed. A concealed covert code provides an additional measure of security since the covert code cannot be viewed and hence transmitted to an authentication authority without it being evident that the package has been tampered with. The covert code may be concealed by means of a removable concealment means bearing the overt code. That is, the overt code is preferably overt and available for scanning throughout the distribution cycle (including by distributors and by consumers prior to purchase of the product), whilst the covert code is only available for scanning by the consumer after purchase, i.e. by removing the upper layer bearing the overt code to reveal the covert code.

Accordingly, the overt code may be interchangeably referred to as the first code, the overt code or the multi-scan code herein. The covert code may be interchangeably referred to as the second code, the covert code or the single-scan code.

Where an additional level of security is deemed necessary, the code pairs are encrypted by the authentication authority. The database only operates with encrypted data, and the only place where the code pairs can be decrypted is inside the database. Accordingly, in the event that the database was to be accessed by a hostile party or a counterfeiter, the only data that would be returned in relation to the codes and code pairs would be indecipherable. All transmissions between the authentication authority and external parties including manufacturers and consumers may also be encrypted using communication channel encryption.

The code pairs may be secured by encryption or hashing using known encryption and/or hashing algorithms, e.g. a standard SHA1 hashing algorithm. This has the advantage that the database of hashed code pairs cannot be “decoded” into their original form since the hashing process is one way. Accordingly, any want-to-be counterfeiter is unable to decode the overt and covert codes and more particularly, the code pairs. The order of values of codes may also be altered. Additionally, hashing data to a fixed size can significantly improve the speed of sorting the data. This confers a particular advantage where potentially 100's of millions of active security labels might exist in a database. The hashing of codes in the database is particularly of use if the database itself is compromised—the stolen overt/covert code data cannot be reversed engineered into the actual codes which need to appear on the products, i.e. a stolen set of code data from the database is not useful. Other known encryption techniques may also be applied.

Referring now to FIG. 3, there is shown an example consumer product provided in a can like packaging 310 with the overt code 320 and covert code 330 applied to its exterior surface. Preferably, the physical removal of the upper layer of the dual layer security label comprising the overt code, will result in obvious evidence of tamper (i.e. damage) to the security label. This will avoid the incidence of a covert code being exposed and re-covered. This can be achievable for example by providing a dual layer security label including a perforation for removal of the upper overt code, such that removal of the overt code via the perforations, exposes the covert code beneath, whilst physically destroying the overt code. Alternately, printing the overt code on a removable surface, such as one that can be scratched off, that is printed over the covert code, would also evidence tamper since the covert code would only be revealed by removing, by scratching or similar, the overt code.

Since the covert code 330 should only be accessed by a purchaser post purchase, and is cancelled following a first attempt to use the covert code to verify the authenticity of the consumer product, it provides an improved level of security over known verification methods and systems. Any attempt to scan the covert code prior to purchase will result in tamper which would be obvious.

The overt code 320 exemplified in FIG. 3, is a two dimensional bar code preferably readable by a bar code scanning application installed on a mobile communications device such as a smart phone. This overt code 320 is overt and is preferably placed over the covert code 330. Covert code 330 is also a two dimensional bar code. Preferably, the codes contain no useful information such as a URL, decipherable item identifier or details of product and/or manufacturer attributes.

Where dual layer security labels are undesirable, such as for example they are not allowed to be used in respect of particular consumer products due to regulatory requirements, what will become the covert code is printed on the consumer product in the first instance. Another printer then prints an ink surface which is removable by scratching, over the “covert” code to conceal it. Yet another printer then prints an overt code over the inked surface. Alternately, the overt code is printed elsewhere on the consumer product.

A computing device in communication with the printers, may generate the codes “on demand”, for example, at the production line and securely encrypt and upload the code pairs to the authentication authority (most likely in a batch process e.g. after the application of every 10,000 codes).

Referring back to FIG. 2, the system 200 may be implemented using hardware, software or a combination thereof and may be implemented in one or more computer systems or processing systems. In particular, the functionality of the host server 210 may be provided by one or more computer systems capable of carrying out the above described functionality.

Such a computer system is illustrated in FIG. 4. In this Figure, an exemplary computer system 400 includes one or more processors, such as processor 410. The processor 410 is connected to a communication infrastructure 420. The computer system 400 may include a display interface 430 that forwards graphics, texts and other data from the communication infrastructure 420 for supply to the display unit 440. The computer system 400 may also include a main memory 450, preferably random access memory, and may also include a secondary memory 460.

The secondary memory 460 may include, for example, a hard disk drive/solid state drive (SSD) 470, magnetic tape drive, optical disk drive, etc. The removable storage drive 480 reads from and/or writes to a removable storage unit 490 in a well-known manner. The removable storage unit 490 represents a floppy disk, magnetic tape, optical disk, USB etc.

As will be appreciated, the removable storage unit 490 includes a computer usable storage medium having stored therein computer software in a form of a series of instructions to cause the processor 410 to carry out desired functionality. In alternative embodiments, the secondary memory 460 may include other similar means for allowing computer programs or instructions to be loaded into the computer system 400. Such means may include, for example, a removable storage unit 500 and interface 510.

The computer system 400 may also include a communications interface 520. Communications interface 520 allows software and data to be transferred between the computer system 400 and external devices. Examples of communication interface 520 may include a modem, a network interface, a communications port, a PCMIA slot and card etc. Software and data transferred via a communications interface 520 are in the form of signals 530 which may be electromagnetic, electronic, optical or other signals capable of being received by the communications interface 520. The signals are provided to communications interface 520 via a communications path 540 such as a wire or cable, fibre optics, phone line, cellular phone link, radio frequency or other communications channels.

It is an advantage of the method and system of the present invention, that the dual layer—two code authentication system, permits partial validation of the consumer product prior to sale, so that any potential purchaser considering purchasing the consumer product is able to scan the overt code and obtain information regarding the identity of the consumer product. Furthermore, the overt code is available for scanning throughout the distribution cycle. However, final verification is available once only to the actual purchaser, who exposes the covert code. Exposing the covert code should leave at least some evidence of tamper. Scanning of this covert code causes an authentication signal to be transmitted to the purchaser provided that the covert code can be verified. Once an attempt to verify a covert code has been made, the code pair is cancelled such that the covert code is no longer operational for authentication purposes. This feature increases the robustness and security level of the method and system of the present invention.

Moreover, manufacturing high volumes of code pairs is technically easy to achieve at a low-cost. Duplication of code pairs would require not only knowledge and capability to generate the individual overt and covert codes in the appropriate format, but also for the association or link between the code pairs to be known. Since the association of overt and covert codes into code pairs occurs securely and is then encrypted into the database, it becomes virtually impossible for a want-to-be counterfeiter to generate code pairs equivalent to those generated by an authentication authority.

Furthermore, providing an opportunity for the purchaser to interact with the authentication authority provides the purchaser with a high degree of confidence that the verification system is robust and trustworthy. It also provides an opportunity to interact with the purchaser to collect valuable data relating to demographics and purchasing behaviour which can be used for targeted marketing campaigns, as well as in a product recall situation.

Although in the above described embodiments the invention is implemented primarily using computer software, in other embodiments the invention may be implemented primarily in hardware using, for example, hardware components such as an application specific integrated circuit (ASICs). Implementation of a hardware state machine so as to perform the functions described herein will be apparent to persons skilled in the relevant art. In other embodiments, the invention may be implemented using a combination of both hardware and software.

While the invention has been described in conjunction with a limited number of embodiments, it will be appreciated by those skilled in the art that many alternative, modifications and variations in light of the foregoing description are possible. Accordingly, the present invention is intended to embrace all such alternative, modifications and variations as may fall within the spirit and scope of the invention as disclosed.

1. A method for verifying of the authenticity of a consumer product, the method including the following steps:
providing an overt code on a consumer product, the overt code being readable prior to sale of the consumer product;
providing a covert code on the consumer product, the covert code being revealed post sale of the consumer product;
receiving a transmission of the covert code from a purchaser of the consumer product;
verifying the covert code by reference to a database;
if the covert code verifies the authenticity of the consumer product, transmitting an authentication signal to the purchaser; and
cancelling the covert code and the overt code once the covert code has been used to verify the authenticity of the consumer product.

2. A method for verifying of the authenticity of a consumer product according to claim 1, further including the following step:
transmitting information regarding one or more discernible product attributes of the consumer product to enable the purchaser to verify that the consumer product matches the one or more discernible product attributes.

3. A method for verifying of the authenticity of a consumer product according to claim 2, wherein a first set of one or more discernible product attributes are associated with the overt code and a second set of one or more discernible product attributes are associated with the covert code.

4. A method for verifying of the authenticity of a consumer product according to claim 3, wherein the second set of one or more discernible product attributes includes the first set of one or more discernible product attributes and additionally at least one other discernible product attribute.

5. (canceled)

6. A method for verifying of the authenticity of a consumer product according to claim 1, further including the step of associating a code pair comprising one overt code and one covert code which will be applied to the same consumer product.

7. A method for verifying of the authenticity of a consumer product according to claim 5, wherein the step of associating a code pair occurs at a secondary location that is remote from one or more primary locations where the overt and covert codes are generated.

8. A method for verifying of the authenticity of a consumer product according to claim 7, wherein the secondary location is associated with an authentication authority.

9. A method for verifying of the authenticity of a consumer product according to claim 1, further including the following step:
if the covert code does not verify the authenticity of the consumer product, transmitting a failure to authenticate signal to the purchaser together with a request for information relating to acquisition of the consumer product.

10. (canceled)

11. A method for verifying of the authenticity of a consumer product according to claim 1, further including the following step of:
transmitting information regarding a product recall affecting the authenticated consumer product to the purchaser.

12. A method for verifying of the authenticity of a consumer product according to claim 1, further including the following step:
providing at least one batch code on a collection of consumer products, the batch code being associated with data that identifies the collection of consumer products prior to sale.

13. A method for verifying of the authenticity of a consumer product according to claim 12, further including the following step:
transmitting information regarding a product recall affecting the consumer product to a distribution channel intermediary.

14. (canceled)

15. A system for verifying of the authenticity of a consumer product, the system including:
one or more code generating modules for providing an overt code and a covert code, wherein the overt code and the covert code are both to be applied to the consumer product;
a database for associating the overt code with data that identifies the consumer product and the covert code with data that can be used to authenticate the consumer product;
a receiving and transmission module for receiving a transmission of the covert code from a communication device associated with a purchaser of the consumer product and transmitting an authentication signal to the communication device via a network, if the covert code verifies the authenticity of the consumer product; and
a code cancellation module for cancelling the covert code and the overt code once the covert code has been used to verify the authenticity of the consumer product.

16. A system for verifying of the authenticity of a packaged consumer product according to claim 15, further including a code linking module for associating a pair of codes comprising one overt code and one covert code in a database.

17. A system for verifying of the authenticity of a packaged consumer product according to claim 16, wherein the code linking module resides at a secondary location that is remote to one or more primary locations where the one or more code generating modules reside.

18. A system for verifying of the authenticity of a consumer product according to claim 16, wherein the associated code pairs are physically linked.

19-20. (canceled)

21. A system for verifying of the authenticity of a consumer product according to claim 15, wherein the covert code is concealed beneath the overt code.

22. A system for verifying of the authenticity of a consumer product according to claim 17, wherein the overt code is removed by a purchaser to reveal the covert code post purchase of the consumer product.

23. A system for verifying of the authenticity of a packaged consumer product according to claim 15, wherein the machine readable code is read by a scanner associated with the communications device.

24. (canceled)

25. A system for verifying of the authenticity of a packaged consumer product according to any one of claim 15, further including a database storing information related to the consumer product, the information relating to the consumer product being transmitted to the communications device together with the covert code.
